(19) United States
(12) Patent Application Publication
(10) Pub. No.: US 2008/0005440 A1
(43) Pub. Date: Jan. 3, 2008

(54) Streaming media cradle

(75) Inventors: Mitchell M. Li, San Diego, CA (US); John Schindler, San Diego, CA (US)

Correspondence Address: GATEWAY, INC.;ATTN: Patent Attorney, 610 GATEWAY DRIVE, MAIL DROP Y-04, N. SIOUX CITY, SD, 57049, US

(73) Assignee: Gateway Inc.

(21) Appl. No.: 11/477,108

(22) Filed: Jun. 28, 2006

(51) Int. Cl. G06F 13/00

(52) U.S. Cl. 710/303

(57) ABSTRACT

A cradle for a portable media device includes logic configured to stream media data from a connected device, e.g., a PC, or the internet, through the cradle to one or more connected devices, such as a television and a stereo. A portable media device can be mounted to the cradle, and the user interface of the device can be displayed on a connected video display. The cradle can be controlled via a connected PC, via an IR-enabled device, and/or via the controls on the portable media device.

### BACKGROUND OF THE INVENTION

1. Field of the Invention

The present invention relates to devices, systems, and processes useful as cradles for portable media players and/or recorders, and more specifically to such a cradle that enables the streaming of media from additional sources and to additional players and/or displays.

2. Brief Description of the Related Art

There are several devices in the market today that are able to automatically discover content on a personal computer (“PC”) and stream the information on the PC to another device, such as a home stereo or digital television. There are also several devices currently commercially available that permit an MP3 player or portable video player to connect to power or sync to a display, but none of these devices are capable of streaming media from a PC to the device or from the device to the PC. There is therefore not a device in the market today that can both stream media from the PC and physically connect to a different, portable device, such as an MP3 player, portable media center, and the like, that allows for the information that is streamed from the PC to be copied, shared, and/or displayed on the portable device itself, and/or on another stationary device with a display such as a television.

### SUMMARY OF THE INVENTION

According to a first aspect of the invention, a cradle useful for streaming data comprises a processor, a memory in communication with the processor, at least one data connector in communication with the processor, one of the at least one data connector configured and arranged to connect to a portable media device, at least two streaming media data connectors in communication with the processor, and logic configured to stream media data from at least one of the at least two streaming media data connectors to the at least one data connector, or from the at least one data connector to at least one of the at least two streaming media data connectors, or from at least one of the at least two streaming media data connectors to another of the at least two streaming media data connectors, or combinations thereof.

According to another aspect of the present invention, a cradle useful for streaming data comprises a processor, a memory in communication with the processor, at least one data connector in communication with the processor, one of the at least one data connector configured and arranged to connect to a portable media device, at least two streaming media data connectors in communication with the processor, and means for streaming media data from at least one of the at least two streaming media data connectors to the at least one data connector, or from the at least one data connector to at least one of the at least two streaming media data connectors, or from at least one of the at least two streaming media data connectors to another of the at least two streaming media data connectors, or combinations thereof.

Still other aspects, features, and attendant advantages of the present invention will become apparent to those skilled in the art from a reading of the following detailed description of embodiments constructed in accordance therewith, taken in conjunction with the accompanying drawings.

### BRIEF DESCRIPTION OF THE DRAWINGS

The invention of the present application will now be described in more detail with reference to exemplary embodiments of the apparatus and method, given only by way of example, and with reference to the accompanying drawings, in which:

FIG. 1 illustrates a exemplary embodiment of a cradle in accordance with the present invention;

FIG. 2 illustrates an exemplary portable media device in accordance with the present invention;

FIG. 3 schematically illustrates portions of a cradle in accordance with the present invention; and

FIG. 4 schematically illustrates an exemplary media streaming system in accordance with the present invention.

### DETAILED DESCRIPTION OF EXEMPLARY EMBODIMENTS

Referring to the drawing figures, like reference numerals designate identical or corresponding elements throughout the several figures.

In general terms, a cradle embodying principles of the present invention enables a portable media device, e.g., an MP3 player, portable video or image player, and the like, that is, otherwise static devices whose main function is to help play back data, to be transformed into a source of data that can be controlled away from a PC.

Turning now to the drawing figures, FIG. 1 illustrates an exemplary cradle 10 embodying principles of the present invention. The cradle 10 includes a housing or base 12 which contains many of the functional components of the cradle, and includes an upward facing or top surface 14. A data, communications, and power connector 16 is formed in or on the top surface 14, and is configured and sized to mate with a correspondingly configured and sized port or ports on a portable media device, described in greater detail below. An optional display 18 is provided so a user of the cradle can view messages and/or data displayed by the logic contained in the cradle.

The cradle 10 includes a number of communications ports or connectors, preferably bidirectional, including, but not limited to: an infrared (IR) communications port 20; audio/video input and output 22; communication links, e.g., USB, IEEE 1394, ethernet, and the like; and combinations of such ports or connectors. Of course, the cradle 10 also includes the necessary controllers and the like to permit the cradle to use all the communications links to transfer data to and from connected devices, as is well known to those of ordinary skill in the art. The cradle 10 preferably includes a power connector 26 for connection to standard A/C power supply, and associated power supplies, etc., for conditioning that power, and may alternatively or additionally include a battery (not illustrated).

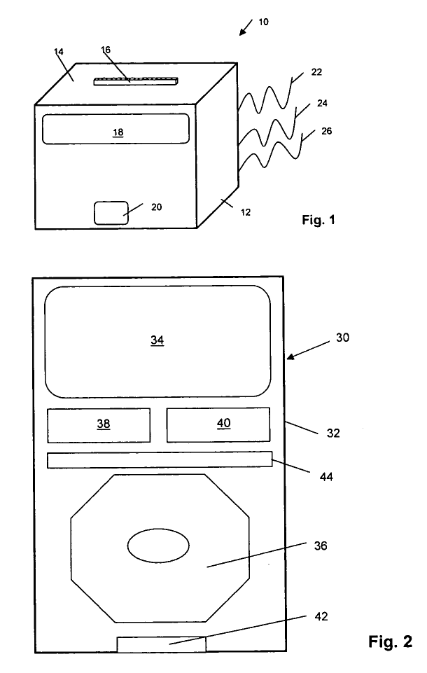

FIG. 2 illustrates an exemplary portable media device 30 which, when used with the cradle 10, can be used to stream media through the cradle to a PC and other connected devices (not illustrated). An exemplary device 30 includes a housing 32 in or on which all of subcomponents of the cradle are positioned, including a display 34, and a user interface and/or control panel 36, e.g., a keypad or the like. A processor, e.g., CPU, 38 is in communication with a memory 40 and an input/output communications port and/or connector array 42, in a manner well known to those of ordinary skill in the art. The array 42 is, as discussed above, configured and sized to mate with connector 16 so that the cradle 10 and the device 30 can exchange data, signals, and power. Additionally, the co-configuration of array 42 and connector 16, as well as the physical configuration of the top surface 14, permits the cradle 10 to hold the device 30 in place on the cradle. To this end, top surface 14 can be any shape that assists in holding the device 30 on and to the cradle 10. A battery 44 is typically provided to provide power to the device 30.

The memory 40 includes one or more of a RAM, ROM, flash memory, hard disk drive, as well as other memory devices, and combinations of such memories. The memory 40 includes a set or sets of logical instructions that are executable by the processor 38 to receive and interpret signals from the user interface 36, control the display 34, control the input and output of data and signal streams through array 42, and input to and read from the memory 40, so that the device 30 functions as a portable media device. More specifically, and by way of non-limiting example, audio data and/or signals, video data and/or signals, control data and/or signal for the device 30 itself, data and/or signals representative of the information presented on display 34, and power can be input from and output to the array 42.

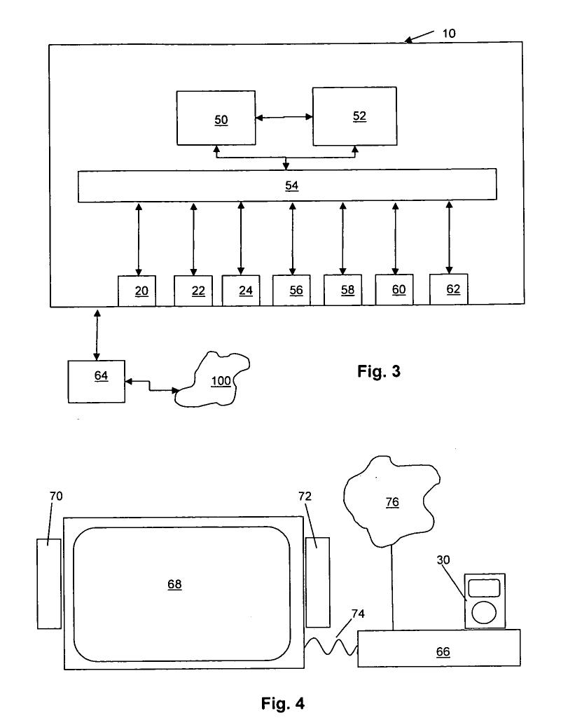

While the device 30 operates as a portable media device in a generally known way, such as by placing the array 42 in communication with a PC for receiving media (e.g., MP3, JPEG, and/or MPEG) data, including synchronization of data sets, a cradle 10 of the present invention further enables the device 30 to stream media data and/or signal to and from additional connected devices. FIG. 3 schematically illustrates portions of the cradle 10, and includes a processor or CPU 50, a memory 52, and an I/O controller 54. The I/O controller 54 is in communication with each of the I/O ports or connectors with which the cradle 10 is provided, including the IR port 20, the A/V ports 22, the communication link or links 24, an RF modulated transmitter 56, a bidirectional wireless link (e.g., IEEE 802.11 (a), (b), and/or (g)), and optional other ports or data sources or destinations 60, 62. As described herein, the cradle 10 can be placed in communication with a PC or other general purpose computing device 64, which can optionally be in communication with the internet 100; alternatively, the cradle 10 can be directly in communication with the internet, such as via an ethernet connection.

The memory 52 includes a set or sets of logical instructions that are executable by the processor 50 to receive and interpret signals from a connected PC, a docked or cradled device 30, and/or via one of the other communications ports, to control the optional display 18, control the input and output of data and signal streams through connector 16 and one or more of the I/O connectors 20, 22, 24, 56, 58, 60, 62, and input to and read from the memory 40, so that the cradle 10 streams data and/or signals. By way of non-limiting examples, the logic of cradle 10 is configured to enable streaming data and/or signals from the device 30, from a connected device such as a PC, and/or from the internet 100, though the cradle to both the device 30 and to a connected device:

audio data and/or signals to a connected audio device, e.g., a stereo;

still image data and/or signals to a connected video device, e.g., a television; and/or

video data and/or signals to a connected video device, e.g., a television.

The logic of cradle 10 is also further optionally configured to enable the cradle to receive IR data signals via the IR port 20 from, e.g., an IR-enabled television remote control device, IR-enabled personal digital assistant (PDA), and other IR-enabled devices, to control the operation of the cradle, operation of a cradled device 30, or both.

The logic of cradle 10 is also further optionally configured to enable the cradle to receive from a cradled device 30 data representative of the device's output to display 34, i.e., the User Interface (UI) and output suitable data or a signal to a connected video device, e.g., a television. In this manner, the limited size of the display 34 does not limit use of the cradle 10, as the same UI can be displayed on a much larger, connected display device.

The logic of cradle 10 is also further optionally configured to enable a cradled device 30 to take over the function of the cradle using the user interface 36 of the portable device, allowing a user to interact with a connected PC, the internet, or connected device.

FIG. 4 schematically illustrates a streaming media system embodying principles of the present invention. A device 66 for streaming content, which may be a cradle device 10, or a DVD player, CD player, or other streaming device embodying logic of the present invention, is in communication with both a network 78 and a display device 68 via a communications link 74. The network 78 may be, in turn, connected to or be the internet 100. The device 66 of the present invention, as described elsewhere herein, includes logic that can stream data from the network 78 to the display 68 and/or audio output devices 70, 72 (e.g., speakers). When a portable media device 30 is attached, the content from the portable media device can be streamed to the output of the device 66, the content from the network 78 can be streamed to the output, the content from the portable media device can be saved to the network (e.g., a sync operation), and/or the content from the network and be used to load (e.g., sync) the portable media device. Further, it should be recognized that the streaming of the data from the device 66 to the network 78 or the display device 68 or the audio output devices 70,72 may provide real time, or substantially immediate, play back of the streamed data without storage of the data for any appreciable time period. However, the streaming of the data may include some manner of storage of the data.

As a further optional feature or function of the invention, the cradle device 10 may provide a conversion or translation function for the data streaming or passing through the device. For example, the cradle 10 may provide a conversion function by converting the data from digital to analog (or analog to digital) as the data moves through the cradle. Further, the cradle 10 may translate the data between different formats or codes, such as, for example, from the MP3 format to the WMA format. Further, the cradle 10 may perform a combination of conversion and translation of the data, such as, for example, changing the data from an MP3 format to an analog form.

Several of the components and subcomponents of the cradle 10 and device 30 are not described in high detail, as such are well known to those of ordinary skill in the art; accordingly, further details will not be provided herein so as to not obscure the principles of the present invention.

While the invention has been described in detail with reference to, exemplary embodiments thereof, it will be apparent to one skilled in the art that various changes can be made, and equivalents employed, without departing from the scope of the invention.

What is claimed is:

1. A cradle useful for streaming data, comprising:
a processor;
a memory in communication with the processor;
at least one data connector in communication with the processor, one of the at least one data connector configured and arranged to connect to a portable media device;
at least one streaming media data connector in communication with the processor; and
logic configured to stream media data:
from the at least one streaming media data connector to the at least one data connector; or
from the at least one data connector to the at least one streaming media data connector; or
from the at least one streaming media data connector to another streaming media data connector; or
combinations thereof.

2. A cradle according to claim 1, wherein one of the at least one data connector comprises an IR port, and further comprising:
logic configured to receive control signals from the IR port and transmit control signals to said one of the at least one data connector configured and arranged to connect to a portable media device, to permit a user to transmit IR signals to the cradle to control operation of said portable media device.

3. A cradle according to claim 1, wherein said at least one streaming media data connector comprises a video signal connector, and further comprising:
logic configured to receive still image data, video data, or both, from another streaming media data connector and transmit video data signals to said at least one streaming media data connector.

4. A cradle according to claim 1, wherein said at least one streaming media data connector is selected from the group consisting of an audio input, and audio output, a video input, a video output, a USB port, an ethernet port, an IEEE 1394 port, an RF modulator port, a wireless bidirectional link port, and combinations thereof.

5. A cradle according to claim 1, further comprising a housing having an upward facing surface, the at least one data connector configured and arranged to connect to a portable media device located on said upward facing surface.

6. A cradle useful for streaming data, comprising:
a processor;
a memory in communication with the processor;
at least one data connector in communication with the processor, one of the at least one data connector configured and arranged to connect to a portable media device;
at least one streaming media data connector in communication with the processor; and
means for streaming media data:
from the at least one streaming media data connector to the at least one data connector; or
from the at least one data connector to the at least one streaming media data connector; or
from the at least one streaming media data connector to another streaming media data connector; or
combinations thereof.

7. A cradle according to claim 6, wherein the at least one data connector comprises an IR port, and further comprising:
means for receiving data signals from the IR port and transmitting data signals to a second one of the at least one data connector configured and arranged to connect to a portable media device, to permit a user to transmit IR signals to the cradle to control operation of said portable media device.

8. A cradle according to claim 6, wherein the at least one streaming media data connector comprises a video signal connector, and further comprising:
means for receiving still image data, video data, or both, from another streaming media data connector and transmit video data signals to said at least one streaming media data connector.

9. A cradle according to claim 6, wherein the at least streaming media data connector is selected from the group consisting of an audio input, and audio output, a video input, a video output, a USB port, an ethernet port, an IEEE 1394 port, an RF modulator port, a wireless bidirectional link port, and combinations thereof.

10. A cradle according to claim 6, further comprising a housing having an upward facing surface, the at least one data connector configured and arranged to connect to a portable media device located on said upward facing surface.

11. A method of streaming data from a device including a processor, a memory in communication with the processor, at least one data connector in communication with the processor, one of the at least one data connector configured and arranged to connect to a portable media device, and at least one streaming media data connector in communication with the processor, the method comprising:
streaming media data from the at least one streaming media data connector to the at least one data connector; or
streaming media data from the at least one data connector to the at least one streaming media data connector; or
streaming media data from the at least one streaming media data connector to another streaming media data connector on the device; or
combinations thereof.

12. A method according to claim 11, wherein streaming media data from the at least one streaming media data connector to the at least one data connector comprises streaming data from a network to a portable media device.

13. A method according to claim 11, wherein streaming media data from the at least one data connector to the at least one streaming media data connector comprises streaming data from a portable media device to a network.

14. A method according to claim 11, wherein streaming media data from the at least one data connector to the at least one streaming media data connector comprises streaming data from a portable media device to a video display, to an audio output device, or to both.

15. A method according to claim 11, wherein streaming media data from the at least one streaming media data connector to another streaming media data connector comprises streaming data from a network to a video display, to an audio output device, or to both.
